(19) United States
(12) Patent Application Publication
(10) Pub. No.: US 2008/0216678 A1
(43) Pub. Date: Sep. 11, 2008

(54) Hot-stamping method and device

(75) Inventor: Xaver Stockli, Richterswil (CH)

Correspondence Address: Maginot, Moore & Beck;Chase Tower, 111 Monument Circle, Suite 3250, Indianapolis, IN, 46204, US

(73) Assignee: Madag Printing Systems AG, Dietikon (CH)

(21) Appl. No.: 12/074,120

(22) Filed: Feb. 29, 2008

Related U.S. Application Data
(63) Continuation of application No. PCT/CH2006/000421, filed on Aug. 10, 2006.

(30) Foreign Application Priority Data
Aug. 31, 2005 (CH) CH 01425/05

(51) Int. Cl. B41F 19/02

(52) U.S. Cl. 101/25; 101/32

(57) ABSTRACT

A method for the hot-stamping a plurality of parts for stamping comprises operatively engaging a surface of at least one printing plate and a surface of a part for stamping in a stamping plane. The method further comprises providing a material which is to be stamped on between the printing plate and the part for stamping in such a manner that, during the operative engagement, the material which is to be stamped on is stamped onto the part for stamping. A stamping force for the stamping acts in a stamping direction approximately perpendicular to the stamping plane. The method further comprises simultaneously moving the surface of the printing plate and surfaces of the parts for stamping relative to each other into and out again from the stamping plane on defined, uniform paths of movement, said paths of movement intersecting a stamping axis during the stamping operation.

### CROSS-REFERENCE TO RELATED APPLICATIONS

This application is a continuation of international patent application no. PCT/CH2006/000421 (which designated the United States), filed on Aug. 10, 2006, and published as WO 2007/025399, the contents of which are incorporated herein by reference.

### BACKGROUND

This application relates to the field of hot-stamping with printing plates.

For advertising purposes, especially in cosmetics, containers and their closures are colored and printed. This applies, for example, to lipsticks, mascaras, tubes of cream, shampoo bottles, etc. The “hot-stamping method” is frequently used for imprints of this type and, in particular, for metal-colored imprints.

For hot stamping, a hot-stamping foil is pressed for a certain time and at a predetermined pressure by a heated printing plate onto a part for stamping which is to be stamped. A color coat which is located on the foil is transferred to the part for stamping using the raised points of the printing plate that form the actual stamping mold. In a variant of the hot-stamping operation, use is made of printing plates without a stamping mold, said printing plates acting on the raised shapes of the part for stamping and transferring the color coat of the foil thereto. In principle, use is made of flat or cylindrical printing plates which are arranged in a fixed or movable manner.

A particular form of the hot-stamping method is rolling stamping. In this case, a cylindrical printing plate which is mounted rotatably about its axis of rotation and a part for stamping are supplied to each other. For this purpose, the part for stamping and/or the printing plate are fastened on slides which are movable in a translatory manner and can be moved relative to each other in a translatory manner on said slides. If the part for stamping and the printing plate are brought into a position with respect to each other, then the actual stamping operation can begin, in which the cylindrical printing plate rotates about its axis such that the predetermined transfer of the color from the foil to the part for stamping takes place by means of the stamping mold of the printing plate—or to a raised shape of the part for stamping in the case of a printing plate without a stamping mold. The rolling speed of the printing plate, the stamping pressure and the temperature of the printing plate are coordinated with the stamping foil and the part for stamping.

The part for stamping here may be a body which is intended to undergo a stamping only on one side, and therefore, for the rolling stamping, either the rotational movement of the printing plate about its axis is combined with a translatory movement, or else the part for stamping, like the printing plate, is a rotationally symmetrical body and is intended to undergo stamping over its entire circumference, and therefore, for the actual stamping operation, the part for stamping is likewise set into rotation and the printing plate and part for stamping thereby roll over each other and the stamping takes place in this manner. The surface speeds of the part for stamping and of the printing plate are in each case coordinated with each other. If required, an adaptation to the external geometry of the part for stamping can take place during the stamping operation by means of a corresponding translatory movement of the slide of the part for stamping or of the slide of the printing plate, and therefore the stamping always takes place at a constant stamping pressure.

Since the stamping temperature may destroy the foil if the application time is too long, after the stamping operation the printing plate has to be removed from the stamping position in the direct vicinity of the foil for the period of time during which the stamped part is removed and a next part for stamping is brought into position. After the stamping operation, the advancing devices and the slides of the printing plate and of the part for stamping are therefore returned into their starting position. The next part for stamping and the stamping foil are subsequently provided for a next stamping operation and the process begins again.

By means of the movement of the slide or of the slides, masses are accelerated and moved with each stamping operation. After the stamping operation, said components have to be set back again into their starting position. This operation requires driving energy, can trigger oscillations and requires time. As a result, the capacity of a stamping installation is substantially affected and limited. The service life of the device is reduced and the outlay on maintenance increased. In addition, the radial positioning of a round printing plate with respect to the part for stamping is possible only to a limited extent, which may have a negative effect on the stamping accuracy. With this type of hot-stamping devices, only parts for stamping which are intended to undergo stamping over their entire circumference or over their entire length on their side facing the printing plate can therefore be processed.

It would therefore be advantageous to develop the known devices and method and to avoid the disadvantages discussed. It would also be advantageous to expand the possibilities of use and to make the devices more flexible. Accordingly, it would be advantageous if the throughput numbers are be increased. It would also be advantageous to increase the service life and/or to reduce the outlay on maintenance for such devices.

### SUMMARY

A hot-stamping method and device is disclosed that is capable of providing the above advantages. In at least one embodiment, the hot-stamping method and device is configured to achieve such advantages by virtue of the fact that, between the individual stamping operations, the printing plate and part for stamping do not undergo any abrupt change in direction at least in the region of a stamping axis, but rather those surfaces of the printing plate and part for stamping which are intended for the stamping move simultaneously and relative to each other into and out again from a stamping plane which is approximately perpendicular to the stamping axis on defined, uniform paths of movement, with said paths of movement intersecting the stamping axis during the stamping operation.

Owing to the fact that the printing plate moves on a closed, preferably approximately ellipsoidal or circular path of movement, to be precise during the entire cycle, i.e. while it is being brought into the stamping position, during the stamping and even as it is being guided back into the starting position, it is possible for the abrupt changes in direction in the region of the stamping axis and therefore vibrations and oscillations to be avoided. So that the stamping always takes place at a constant stamping pressure, if necessary, during the stamping operation, an adaptation may take place to the external geometry of the part for stamping by combining the movement of the printing plate and/or of the part for stamping on the respective, closed, uniform path of movement with a translatory movement along the stamping axis.

It is particularly advantageous if the extent of the path of movement is selected to be greater than a length, which extends along the extent, of that surface of the printing plate which is intended for the stamping. In this manner, the time between the printing plate moving out of the stamping plane and the printing plate entering the stamping plane again can be used in order to place a next part for stamping into the stamping plane and to bring the stamping foil into the required position.

If, instead of a single printing plate, a number n of printing plates, where n=1, 2, 3, . . . , circulate on the path of movement, and if a section which is free from printing plates is provided between each of the printing plates, then a period of time t1, in which a section which is free from printing plates passes in each case through the stamping plane, can be selected in such a manner that the time t1 corresponds to a period of time t2 in which a next part for stamping is supplied to the stamping plane.

It is particularly advantageous if the circulating speed and the position of the printing plate or of the printing plates can be adjusted in a specific manner at any time, since this increases the stamping accuracy.

If the circulating speed, position and positioning of parts for stamping can be adjusted at any time, this also has an effect on the stamping accuracy, and the rolling hot-stamping method according to at least one embodiment of the invention can also be used to stamp parts for stamping which are intended to undergo stamping only on part of their circumference or on their side which faces the printing plate.

If the length of the sections which are free from printing plates and the time t2 which is required for the supplying of a next part for stamping are coordinated well with each other, then it is possible to keep the adjustable circulating speed of the printing plates on their path of movement virtually constant. “Adaptive controls” may be particularly expediently used for this.

The hot-stamping method described can very advantageously be carried out on a hot-stamping device according to at least one embodiment of the invention with a supply of parts for stamping and at least one printing plate. In the device according to at least one embodiment of the invention, the at least one printing plate is mounted movably in a printing plate holder and/or each part for stamping is mounted movably by means of its respective surface which is intended for the stamping in a receptacle of the supply of parts for stamping in such a manner that those surfaces of the part for stamping and of the printing plate which are intended for the stamping can be brought into operative engagement with each other in a stamping plane. In this case, a stamping foil with material which is to be stamped on is arranged between the part for stamping and the printing plate in such a manner that, during the operative engagement, the material which is to be stamped on can be stamped onto the part for stamping with the aid of the printing plate and a stamping force necessary for the stamping acts in a stamping axis approximately perpendicular to the stamping plane. For those surfaces of the printing plate and part for stamping which are intended for the stamping, the device has a respective path of movement, which paths of movement have a uniform, defined course and each intersect the stamping axis approximately in the stamping plane. With the aid of a control, the part for stamping and the printing plate are coordinated with each other on their respective paths of movement and are movable relative to each other in such a manner that they can be brought into operative connection with each other in the stamping plane.

The paths of movement of the hot-stamping device according to at least one embodiment of the invention are free from abrupt changes in direction at least in the region of the stamping plane and are particularly advantageously designed as a closed, preferably ellipsoidal or circular curve. This avoids mass accelerations between the stamping operations and oscillations and vibrations possibly resulting therefrom. The path of movement of the printing plate is advantageously greater than a length, which extends along the path of movement, of that surface of the printing plate which is intended for the stamping. In this manner, the time between the printing plate being guided out of the stamping plane and the printing plate being supplied again to the stamping plane can be used in order to place a next part for stamping into the stamping position in the stamping plane, which makes a higher throughput possible.

In a particularly preferred embodiment, a number n of printing plates, where n=1, 2, 3, . . . , is arranged in a circulating manner on the path of movement, with a section which is free from printing plates preferably being provided between the printing plates and the length of said section being dimensioned in such a manner that, in interaction with an adjustable circulating speed of the printing plates on their path of movement, it can be coordinated with the time which is required for the supplying of a next part for stamping. A further increase in the throughput is therefore possible.

The device can be realized in a particularly simple manner if the printing plate holder is designed as a rotatably mounted cylinder and the printing plate or the printing plates is or are arranged on said cylinder. In such a refinement, either the printing plate itself or the printing plates themselves can be designed such that they are heatable, or else the cylinder is heatable and the printing plate or the printing plates are heatable via the cylinder. An indirect temperature control of the printing plate or of the printing plates is also possible, for example in a known manner by means of infrared radiators.

In a further preferred embodiment, the printing plate or the printing plates is or are provided with a drive and a control such that the circulating speed and the position of the printing plate or of the printing plates can be adjusted at any time. One or more sensors are provided along the path of movement of the printing plates for precise control and positioning. Said sensors can be designed in the form of light barriers, cameras, etc.

The supply of parts for stamping is advantageously also provided with at least one drive and a control such that the circulating speed, the position and the positioning of the parts for stamping in their receptacles can be adjusted at any time. This control is also preferably supplied with information from one or more sensors installed along the path of movement of the parts for stamping which are to be moved. Said sensors can be designed in the form of light barriers, cameras, etc. However, positioning aids can also be provided which interact, for example, with notches or projections of the parts for stamping and thus permit positioning.

An advantageous refinement of the supply of parts for stamping is a supply revolver in which the receptacles are configured in the form of mandrels or clamps. However, the configuration in the form of a mandrel conveyor or clamp conveyor is also advantageous. In such a conveyor, the clamps or mandrels are movable along the path of movement with the aid of a conveying member, such as, for example, a pulling belt or a chain. It is particularly advantageous if the distance between the mandrels or clamps of the conveyor can be adjusted in a flexible manner, since irregularities in the supplying of parts for stamping can thereby be compensated for very easily. If the mandrels or clamps are mounted rotatably about their axis and indeed can be driven in a rotating manner, then the precise positioning is particularly easy to realize.

In order for the stamping of a part for stamping to take place at a constant stamping pressure, the closed, uniform path of movement of the printing plate and/or of the part for stamping can be combined, if required, in the region of the stamping axis with a translatory movement. For this purpose, either the printing plate can be configured in a manner corresponding to the external geometry of the part for stamping, as a development thereof, or else the slide on which the printing plate is arranged with its printing plate holder executes a translatory movement of this type.

By means of the above-described embodiments, shorter cycle times and higher throughput numbers and a longer service life are achieved on account of lower mass movements and largely uniform movements. The use of the device according to at least one embodiment of the invention and of the method according to at least one embodiment of the invention permits diverse stamping which is not restricted to circumferential or entire-side stampings.

The above described features and advantages, as well as others, will become more readily apparent to those of ordinary skill in the art by reference to the following detailed description and accompanying drawings. While it would be desirable to provide a hot stamping method and/or device that provides one or more of the above-mentioned advantages, or other advantageous features as may be apparent to those reviewing this disclosure, the teachings disclosed herein extend to those embodiments which fall within the scope of the appended claims, regardless of whether they accomplish one or more of the above-mentioned advantages.

### BRIEF DESCRIPTION OF THE DRAWINGS

Embodiments of the invention are explained below by way of example with reference to figures. In the figures, the same objects are basically denoted by the same reference numbers. Purely schematically, in the figures:

FIG. 1a shows a hot-stamping device according to the prior art;

FIG. 1b shows, in enlarged form, a printing plate and part for stamping from FIG. 1a;

FIGS. 2a, 2b show a further hot-stamping device according to the prior art;

FIG. 3a shows a hot-stamping device according to at least one embodiment of the invention;

FIG. 3b shows the hot-stamping device according the embodiment of the invention from FIG. 3a during the stamping operation;

FIG. 4 shows examples of parts for stamping with a geometry different from a cylindrical geometry;

FIG. 5 shows examples of printing plates with a shape matched to the geometry of the part for stamping; and

FIG. 6 shows a further hot-stamping device according to at least one embodiment of the invention.

### DESCRIPTION

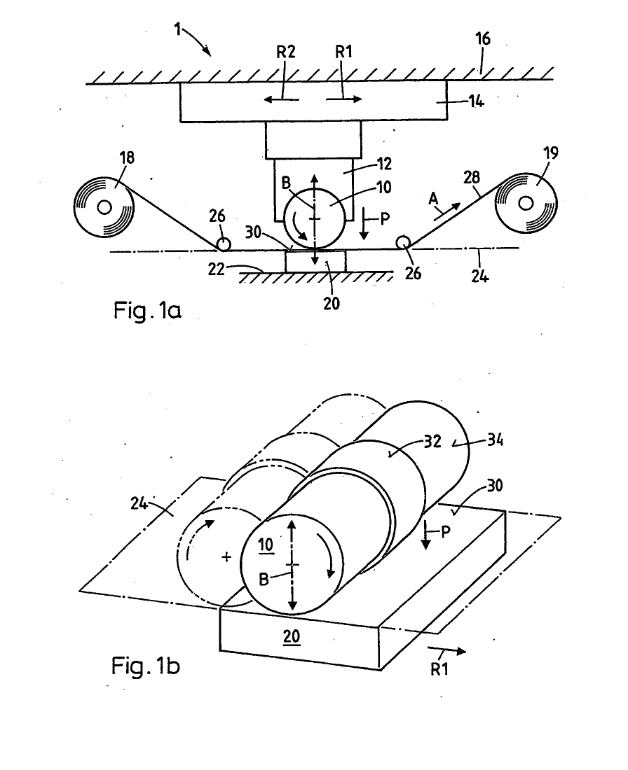

FIG. 1a illustrates a hot-stamping device 1 according to the prior art, which has a heatable, cylindrical printing plate 10 which is mounted rotatably in a printing plate holder 12. The printing plate holder 12 is connected in FIG. 1 to a slide 14 which is movable in a first translatory direction R1 in a machine frame 16. The printing plate holder 12 is mounted movably in the slide 14 in a second translatory direction along the stamping axis B, the stamping axis B in this example being perpendicular to the first translatory direction R1. A part 20 which is to be stamped and, in this example, is of cuboidal design with a planar surface 30 facing the printing plate 10 for stamping purposes is mounted in a defined position on a support 22 for the stamping operation. A stamping plane 24 stretches between the part for stamping 20 and the printing plate 10. A stamping foil 28 is clamped by means of deflection rollers 26 between an unwinding device 18 and a winding-up device 19 in a manner such that it runs through the stamping plane 24 in the arrow direction A. On its side facing the part for stamping, the stamping foil 28 has a material which is to be stamped on and which is transferred during the stamping operation to the part for stamping 20 at an appropriate temperature of the printing plate 10 and predeterminable pressure. For the stamping operation, the part for stamping 20 is positioned with its planar surface 30 parallel to the stamping plane 24 just below the stamping foil 28 or is positioned in the stamping plane 24. FIG. 1b schematically illustrates the heatable printing plate 10 and the part for stamping 20 from FIG. 1 in an operative connection to each other, with the stamping foil which is located between them not being illustrated for the sake of simplicity.

For the stamping operation, the printing plate 10 has a surface 32 which is intended for the stamping and which is of raised design in comparison to a basic surface 34 of the printing plate 10. For the stamping operation, the printing plate 10 is brought, with the aid of the slide 14, out of a starting position (not illustrated) offset laterally with respect to the part for stamping 20 above the stamping foil 28 into a stamping position (indicated by dashed lines) in which that surface 32 of the printing plate 10 which is intended for the stamping and a surface 30 of the part for stamping 20 that is intended for the stamping come into operative connection with each other in the stamping plane 24 such that the material to be stamped on is stamped onto the part for stamping 20 by the stamping foil 28. For this purpose, the heated printing plate 10 is pressed at a predetermined, constant pressure P against the stamping foil 28 and the part for stamping 20 in the stamping direction B and is rolled on the stamping foil 28 and the part for stamping 20 in the direction R1. Depending on the composition of the printing plate 10, the part for stamping 20 and the stamping foil 28, the printing plate 10 is held at a certain temperature T and the speed of movement in the translatory direction R1 and the rolling speed of the cylindrical printing plate 10 on the part for stamping 20 and also the stamping pressure P are predetermined. The printing plate 10 and part for stamping 20 thereby come into operative connection with each other for a defined time t1 at a defined, constant pressure P.

After the stamping operation, the printing plate 10 is moved in a translatory manner, in a first lifting movement, in the opposite direction to the applied stamping pressure P along the stamping axis B in order to remove the printing plate 10 from the part for stamping 20 and the stamping film 28. With the aid of the slide 14, the printing plate 10 is guided back by a further translatory movement in the direction R2 into the starting position (not shown). The part for stamping 20 which is now provided with the stamping is removed from the support 22 and a next part for stamping 20 is positioned on the support 22. The entire sequence now begins again, namely the bringing of the printing plate 10 from the starting position into the stamping position, the stamping, the subsequent resetting of the printing plate 10 into the starting position and the removal of the stamped part 20 and the supply of a next part for stamping 20. The removal and supply of the parts for stamping 20 takes place by means of a supply of parts for stamping, which can be embodied, for example, in the known form of a robot.

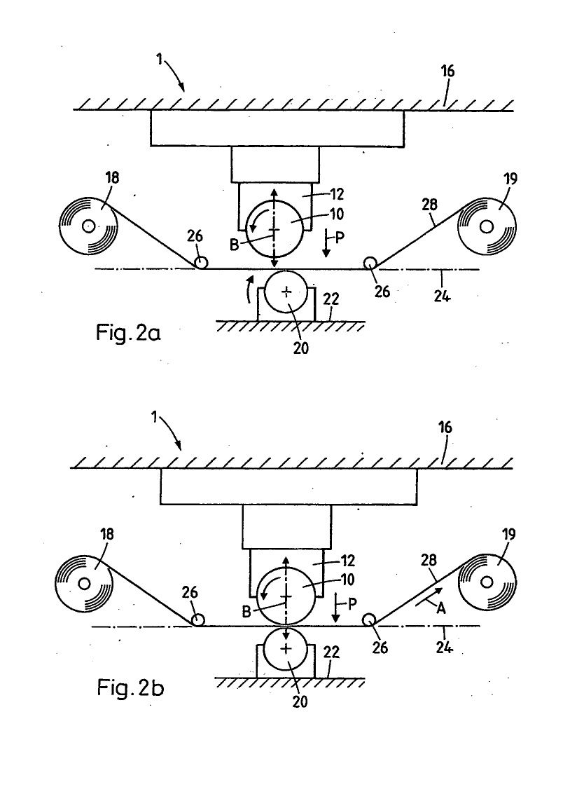

FIGS. 2a, 2b illustrate a further hot-stamping device 1 according to the prior art. In principle, it is of identical construction as that from FIGS. 1a, 1b, only in that, in this example, the parts for stamping 20 are rotationally symmetrical bodies which, like the printing plate 10 with which they interact, are mounted rotatably about their axis of rotation. In this embodiment, for the stamping operation, the printing plate 10 is brought from the starting position, as illustrated in FIG. 2a, with a translatory movement along the stamping axis B in the direction of the stamping pressure P into the stamping position as illustrated in FIG. 2b. For the actual stamping, the cylindrical printing plate 10 is brought into a rotational movement by means of a motor (not illustrated), with the part for stamping 20 rotating about its axis at the same peripheral speed as the printing plate 10 either on account of frictional force or likewise in a motor-driven manner, by means of the same motor or its own motor. The stamping foil 28 is moved at the same time at a speed corresponding to the peripheral speed between the part for stamping 20 and the printing plate 10 in the direction A and is wound up on the winding-up device 19.

Since the printing plate 10 is heated at temperatures T of up to 300° C., there is the risk that, at only a minimally longer application time than required for the stamping operation, the stamping foil will be damaged by the high temperatures and will even tear. In order to be able to remove the part for stamping 20, the printing plate 10 therefore has to be brought again by a translatory movement along the stamping axis B into the starting position. The distance to the printing plate 10 has to be selected here to be of a size such that the heat of the heated printing plate 10 does not put the stamping foil 28 at risk. This also applies, of course, to the hot-stamping device from FIGS. 1a, 1b.

The hot-stamping devices 1 according to FIGS. 1a, 1b are only used nowadays for parts for stamping 20 which are intended to undergo stamping on their side facing the printing plate 10 in the direction R1 of their entire length or, in the hot-stamping device according to FIGS. 2a, 2b, over their entire circumference. As described above, it is necessary in these hot-stamping devices to move the printing plate 10 between the individual stamping operations by means of a translatory movement along the stamping axis B—and in the case of the device according to FIGS. 1a, 1b also along the directions R1, R2; this requires time, as a result of which the possible throughput numbers of parts for stamping 20, i.e. the number of parts for stamping 20 which can be processed per unit of time, is limited. In addition, the translatory movements lead to oscillations in the device which have a negative effect on the accuracy of the stamping and on the service life of the device and/or on various components of the device, which increases the outlay on maintenance.

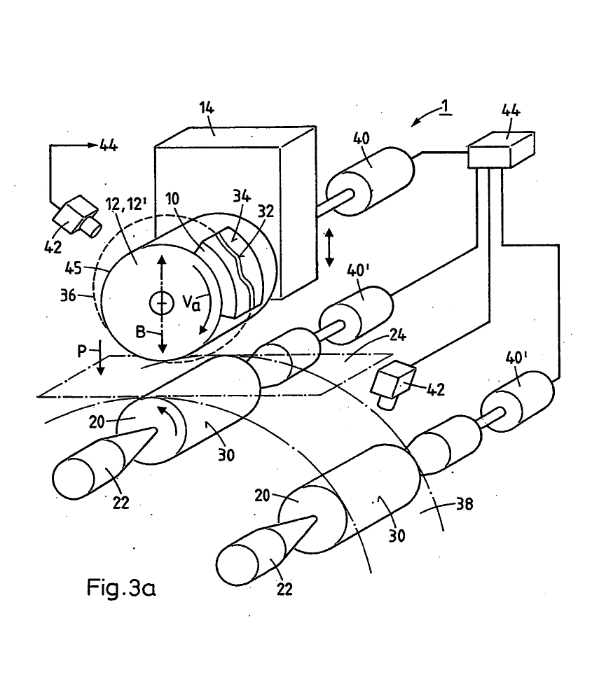

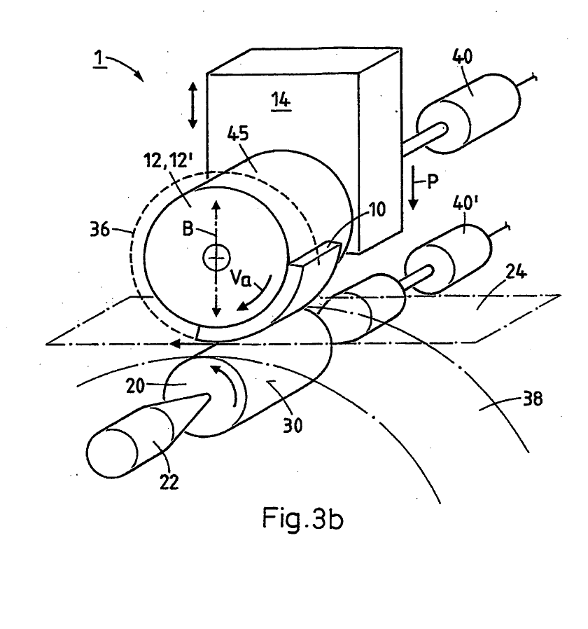

FIGS. 3a, 3b illustrate a hot-stamping device 1 according to at least one embodiment of the invention for the stamping of parts for stamping 20. FIG. 3a illustrates the printing plate 10 again in a non-stamping position and FIG. 3b illustrates it in a stamping position. According to at least one embodiment of the invention, the printing plate 10 or that surface 32 of the printing plate 10 which is intended for the stamping moves in the hot-stamping device 1 according to the embodiment of the invention on a defined, uniform, first path of movement 36, and the part for stamping 20 or that surface 30 of the part for stamping 20 which is intended for the stamping moves, according to the embodiment of the invention, on a defined, uniform, second path of movement 38. The paths of movement 36, 38 intersect the stamping axis B approximately in the stamping plane 24. The printing plate 10 and part for stamping 20 are moved relative to each other and are coordinated with each other in their speed on the respective path of movement 36, 38 in such a manner that they enter into operative connection with each other in the stamping plane 24 and a stamping of the part for stamping 20 takes place. For this purpose, the peripheral speeds of the part for stamping 20 and printing plate 10 and also the speed of the stamping foil, which is not illustrated here for the sake of better clarity, are synchronized. During the stamping operation, the printing plate 10 rolls by means of its surface 32 which is intended for the stamping over that surface 30 of the part for stamping 20 which is intended for the stamping and over the stamping foil located in between, to be precise at a predetermined rolling speed Va which is preferably constant, and at a predetermined temperature T and at a predetermined, constant stamping pressure P.

The part for stamping 20 can again either be designed with a corresponding elevation, on which stamping takes place, and the printing plate 10 can correspondingly have a planar surface, or else vice versa. Printing plates 10 and parts for stamping 20 with a planar surface can likewise be used with an “image foil” then running between them. In addition to a colored writing, logo or image, the image film has a colorless surround. During the stamping operation, the entire contact region between the printing plate 10 and the part for stamping 20 is then stamped, but only the colored writing, the logo or image is visible afterward on the part for stamping 20.

In the example of a hot-stamping device 1 according to the embodiment of the invention which is shown here, in FIGS. 3a, 3b, the printing plate holder 12 is designed as a cylinder 12′ and the path of movement 36 of the printing plate 10 or its surface 32 which is intended for the stamping corresponds to a closed circular path. The printing plate 10 is heated via the heatable cylinder 121 and covers only part of the circumference of the cylinder 12′. In the example shown here, only the printing plate 10 is heatable. However, it is also conceivable to design the cylinder 12′, as the printing plate holder 12, to be heatable and to heat the printing plate 10 via the cylinder. It is likewise possible to indirectly heat the printing plate 10, for example with the aid of an insulated heat chamber which is assigned to the printing plate holder and heats up the cylinder 12′ and the printing plate 10, for example via infrared radiators, electric heating coils, gas burners, etc.

The cylinder 12, is driven by a motor 40 by means of which the rotational movement and the rotational positioning of the cylinder 12′ can be precisely defined. In this example, a supply revolver is indicated as the supply of parts for stamping, said supply revolver being equipped in a known manner with mandrels as receptacles 22 for the parts for stamping 20, with it also being possible, depending on the shape of the part for stamping, for clamps and/or vacuum and/or compressed-air devices to be used as receptacles 22. For the precise positioning of the printing plate 10 and the part for stamping 20 and for the coordination of the circulating speeds, the mandrels 22 and the cylinder 12′ are driven in a rotational manner by means of a respective motor 40, 40′. The coordination and precise positioning are ensured with the aid of sensors 42 along the paths of movement 36, 38 and a preferably adaptive control 44.

After the start of the cycle, the printing plate 10 is advanced with the advancing slide 14 (as an alternative, the part for stamping 20 can also be advanced). The printing plate 10 and part for stamping 20 then rotate in such a manner that the surface speed and rotational positioning are synchronized with each other. The stamping operation then takes place by transmission of pressure and temperature from the printing plate 10 to the foil 28 and the part for stamping 20 located therebelow. After the end of the stamping operation, the part for stamping 20 is brought to a halt. The processed part for stamping 20 can be removed and a new one supplied. As an alternative, a different receptacle 22 is brought into the stamping position by a suitable device. During this, the printing plate 10 continues to rotate on the side which faces away from the part for stamping 20, and the stamped part can easily be guided away and a next part for stamping supplied. At the correct time, the surface speed and rotational positioning of the part for stamping and the printing plate are in turn synchronized with each other and the next stamping carried out.

The advancing slide 14 with the printing plate 10 is not reset between the individual stamping operations. The necessary free positioning between the printing plate 10 and the part for stamping 20 is achieved along the path of movement 36 by that section 45 of the cylinder 12′ which is not covered by the printing plate 10. Only when the installation is at a full standstill is the advancing slide 14 reset.

During the continuous operation, the speed of the cylinder 12′ between the end of the stamping operation and renewed beginning of the stamping operation is calculated and optimized on the basis of the average cycle time by the adaptive control 44, and therefore the rotation of the cylinder 12′ which is as uniform as possible can take place.

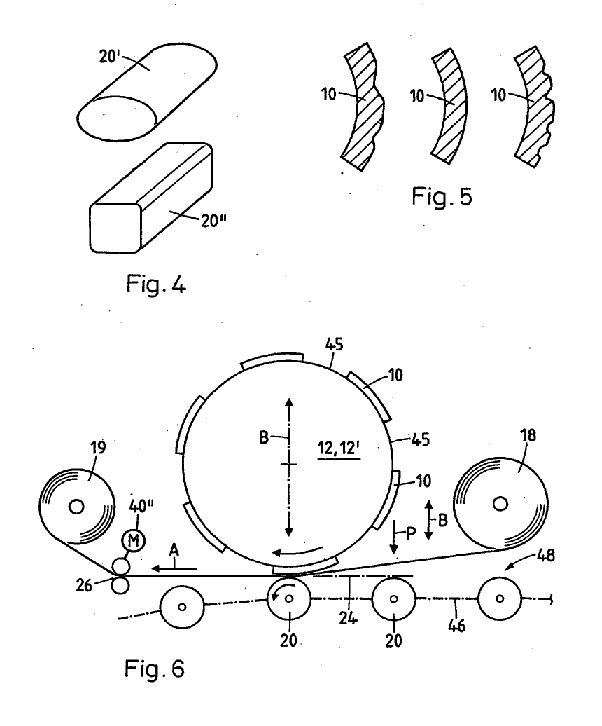

In the case of non-cylindrical parts for stamping 20′, 20″ as illustrated in FIG. 4, the adaptation to the shape or external geometry of the part for stamping 20′, 20″ takes place by combining the movement of the printing plate 10 on its uniform path of movement 36 and the translatory movement of the advancing side 14 with the printing plate holder 12/12′ and the printing plate 10. For this purpose, the part for stamping has first of all to be precisely measured and the precise movement then prescribed for the slide, for example by means of corresponding programming. Of course, a translatory movement can be combined with the part for stamping 20 instead of with the printing plate 10.

A further possibility of stamping non-cylindrical parts for stamping 20′, 20″, as illustrated in FIG. 4, is to adapt the surface topography of the printing plate 10 used such that it corresponds to the external geometry of the part for stamping 20, as illustrated in the printing plates 10 in FIG. 5.

FIG. 6 shows a further embodiment of the hot-stamping device 1 according to at least one embodiment of the invention which is constructed in principle in the same manner as the hot-stamping device 1 from FIGS. 3a, 3b. In contrast to the hot-stamping device 1 in FIGS. 3a, 3b, the supply of parts for stamping is designed in this example, instead of in the form of a revolver, in the form of a conveyor 48 with a conveying member 46 which, in this special case, is configured as a chain. Furthermore, in this example, the printing plate holder 12 is configured as a cylinder 12′ with a very large diameter and printing plates 10 which are spaced apart from one another by means of equally sized sections 45 which are free from printing plates are arranged on the circumference of the cylinder. However, it is also conceivable likewise to move the printing plates 10 by means of a conveyor instead of on a cylinder. In the example shown here, the printing plates 10 are relatively flat and can therefore be heated individually. The time t1 which sections 45 which are free from printing plates require to pass through the stamping plane 24 in the intersecting region with the stamping axis B and the time t2 which is required for the supply of a next part for stamping 20 are again coordinated with each other by means of a control (not illustrated) in such a manner that it is possible to keep the adjustable circulating speed of the printing plates 10 on their path of movement 36 virtually constant.

The embodiments illustrated in the figures serve to clearly explain embodiments of the invention by way of examples. It is clear to a person skilled in the art that there are further possibilities of configuring and embodiments of the invention. It is also clear to a person skilled in the art how the elements shown in the various figures can be expediently combined, and therefore the examples shown in the figures do not have any restricting effect whatsoever.

What is claims is:

1. A method for the hot-stamping a plurality of parts for stamping, the method comprising:
(a) operatively engaging a surface of at least one printing plate and a surface of a part for stamping of the plurality of parts for stamping in a stamping plane;
(b) providing a material which is to be stamped on between the printing plate and the part for stamping in such a manner that, during the operative engagement, the material which is to be stamped on is stamped onto the part for stamping with the aid of the printing plate, wherein a stamping force for the stamping acts in a stamping direction approximately perpendicular to the stamping plane; and
(c) simultaneously moving the surface of the printing plate and surfaces of the parts for stamping relative to each other into and out again from the stamping plane on defined, uniform paths of movement, said paths of movement intersecting a stamping axis during the stamping operation.

2. The method as claimed in claim 1, wherein the printing plate moves on a closed, preferably approximately ellipsoidal or circular path of movement, with the extent of the path of movement in particular being greater than a length, which extends along the extent, of the surface of the printing plate which is intended for the stamping.

3. The method as claimed in claim 2, wherein the at least one printing plate comprises a plurality of printing plates with a section which is free from printing plates being provided between each of the plurality of printing plates, the method further comprising the step of circulating the plurality of printing plates on the path of movement, wherein the section which is free from printing plates passes through the stamping plane in a period of time which corresponds to a period of time in which a next part for stamping is supplied to the printing plane.

4. The method as claimed in claim 1, wherein a circulating speed and position of at least one the printing plate are adjusted in a specific manner at any time.

5. The method as claimed in claim 4, wherein the circulating speed, position and positioning of the parts for stamping are adjusted at any time.

6. The method as claimed in claim 3, wherein the length of the section which is free from printing plates and the time which is required for the supplying of a next part for stamping are coordinated with each other in such a manner that the adjustable circulating speed of the printing plates on their path of movement is kept virtually constant.

7. A hot-stamping device configured to receive a supply of parts to be stamped, the hot-stamping device comprising:
at least one printing plate configured to stamp the supply of parts, the at least one printing plate including a stamping surface, the at least one printing plate moveably mounted such that the stamping surface is moveable;
at least one receptacle for a part to be stamped from the supply of parts to be stamped, the part to be stamped moveably mounted such that a surface of the part to be stamped is moveable, wherein the stamping surface of the printing plate and the surface of the part to be stamped are moveable such that they can be brought into operative engagement with each other in a stamping plane,
a stamping material arranged between the stamping surface of the printing plate and the surface of the part to be stamped in such a manner that the stamping material can be stamped onto the part to be stamped when the printing plate operatively engages the part to be stamped, wherein the hot stamping device is further configured to apply a stamping force for the stamping in a stamping direction approximately perpendicular to the stamping plane; and
wherein the stamping surface of the printing plate and the surface of the part to be stamped are configured to be moved relative to each other on defined, uniform paths of movement, wherein the paths of movement intersect the stamping axis approximately in the stamping plane, and wherein the movements of the printing plate and the part to be stamped are coordinated with each other such that said printing plate and said part to be stamped can be brought into operative engagement with each other in the stamping plane.

8. The hot-stamping device as claimed in claim 7, wherein the paths of movement are free from abrupt changes in direction at least in the region of the stamping plane.

9. The hot-stamping device as claimed in claim 7, wherein the path of movement of the printing plate constitutes a closed, ellipsoidal or circular curve, with the extent of the path of movement of the printing plate being greater than a length of the stamping surface.

10. The hot-stamping device as claimed in claim 7, wherein the at least one printing plate comprises a plurality of printing plates, the plurality of printing plates arranged in a circulating manner on the path of movement of the printing plates, with a section which is free from printing plates preferably being provided between the printing plates, the length of said section being dimensioned in such a manner that, in interaction with an adjustable circulating speed of the printing plates on their path of movement, the length being coordinated with the time which is required for supplying a next part for stamping.

11. The hot-stamping device as claimed in claim 7, wherein the at least one printing plate is heated.

12. The hot-stamping device of claim 7, wherein the at least one printing plate is arranged on a heatable cylinder.

13. The hot-stamping device as claimed in claim 7, wherein the at least one printing plate is provided with a drive and a control such that the circulating speed and the position of the at least one printing plate is adjustable at any time, and wherein one or more sensors are provided for the control and positioning of the at least one printing plate along the path of movement of the printing plate.

14. The hot-stamping device as claimed in claim 7, wherein the supply of parts to be stamped is provided with at least one drive and a control such that a circulating speed, position and positioning of the parts to be stamped can be adjusted at any time, and wherein one or more sensors are provided for the control of the parts to be stamped which are moved along the path of movement of the parts to be stamped.

15. The hot-stamping device as claimed in claim 7, wherein the supply of parts to be stamped is provided by a revolver wherein the at least one receptacle is configured in the form of a mandrel or a clamp.

16. The hot-stamping device as claimed in claim 7, wherein the supply of parts to be stamped is provided by a conveyor wherein the at least one receptacle is configured in the form of a plurality of mandrels or clamps and the distance between the mandrels or clamps is adjustable.

17. The hot-stamping device as claimed in claim 7, wherein the at least one receptacle is mounted rotatably about an axis and is configured to be driven in a rotating manner.

18. The hot-stamping device as claimed in claim 7, wherein the at least one receptacle is provided with a vacuum connection and a compressed air connection.

19. The hot-stamping device of claim 7, wherein the printing plate includes a surface topography matched to an external geometry of the part to be stamped.
